(19) United States
(12) Patent Application Publication
(10) Pub. No.: US 2023/0240256 A1
(43) Pub. Date: Aug. 3, 2023

(54) COMBINED TOILETING AND HYGIENE SYSTEM FOR A CAT

(71) Applicant: Brian David Gibbs, Chester (GB)

(72) Inventor: Brian David Gibbs, Chester (GB)

(21) Appl. No.: 17/590,540

(22) Filed: Feb. 1, 2022

(51) Int. Cl. A01K 1/01; A01K 15/02; B07B 1/02

(52) U.S. Cl. CPC A01K 1/011; A01K 15/024; B07B 1/02

(57) ABSTRACT

A combined toileting and hygiene system for a cat, the system comprising: a support device having a first shelving level and a second shelving level, the second shelving level being vertically elevated with respect to the first shelving level; a litter tray associated with the first shelving level; and a container on the second shelving level which is dimensioned to hold one or more hygiene items for the litter tray.

### FIELD OF THE INVENTION

The present invention relates to a pet device, and associated apparatus; more particularly a device and associated apparatus for provision of a toileting area, and most particularly to a combined toileting and associated cleaning station, for an animal; more particularly but not exclusively a pet cat.

### BACKGROUND

Increasing numbers of people in many societies keep pet animals.

Many users will enjoy keeping pet cats in particular, as they are easy to care for and relatively self-sufficient. As an alternative to their natural instinct of finding a suitable toileting place in an outside space, cats can be taught to use an indoor toileting area. Combined with the well-established method of using loose granular ‘litter’ placed in a suitable tray, the toiletting requirements for a pet cat can be combined with the appropriate cleaning tools, materials and sundries required by its owner to achieve a more efficient and less labour intensive process of maintaining hygiene and cleanliness in the home. The provision of an interior toileting facility is essential where pet cats are kept indoors.

Since the litter tray will require cleaning at least once per day, a number of tools and sundries are required in order to keep the tray and surrounding area clean. In a world of decreasing available space however it can sometimes be impractical to keep the tray, new and used litter, disposable gloves, litter bin liners, wet wipes, associated cleaning tools and other cleaning products in one area of their property.

U.S. Pat. No. 9,713,315 (SWEETMAN) discloses a reconfigurable cat litter box and method of manufacturing same, including a base and a cover mountable atop the base. The cover includes a hinged lid for the cat owner to access the interior of the box. The cover has a first end wall defining a first access opening and an opposing second end wall defining a second access opening for the cat. The base includes an upright blocking panel to cover the first access opening or optionally to cover the second access opening. If the first access opening is adjacent a wall or furniture, then the first access opening is blocked by the blocking panel and the cat accesses the box through the second accessing opening. If the second opening is adjacent a wall or furniture, then the second access opening is blocked by the blocking panel and the cat accesses the box through the first accessing opening.

US 2009 0 250 014 (JUAN) discloses a cat litter box that has a housing and a tray. The housing has a bottom segment and a top segment. The bottom segment has a lower chamber, a front open end and a slope. The slope is formed in the lower chamber. The top segment is formed on the bottom segment and has an upright passage and a front entrance. The upright passage is above the slope. The tray is mounted in the lower chamber through the front open end. The cat litter box is configured to provide litter-cleaning procedures to cats so that a cat may drain in the cat litter box without bring inadvertently out litter particles to pollute everywhere to result in frequently cleaning of the indoor environment.

DE 202 004 007 191 (KNICKENBERG) discloses a cat litter tray comprises an upper tray with a perforated floor and a lower tray with a perforated lid. A lock holds these in a position where the perforations do not coincide. When this is removed the upper tray can be slid sideways so that clean cat litter falls through while contaminated litter and faeces are retained.

The present invention arose in order to overcome problems suffered by existing devices.

### SUMMARY OF THE INVENTION

According to a first aspect of the invention there is provided a combined toileting and hygiene system for a cat, the system comprising: a support device having a first shelving level and a second shelving level, the second shelving level being vertically elevated with respect to the first shelving level; a litter tray associated with the first shelving level; and a container on the second shelving level which is dimensioned to hold one or more hygiene items for the litter tray.

Preferably, a screening member may be provided which is positionable between the first and second shelving levels.

Preferably, the screening member is a curtain which hangs from the second shelving level.

Preferably, at least one of the first and second shelving levels may comprise substantially planar surfaces.

Preferably, a perimetric edge of the at least one of the first and second shelving level may curve upwardly.

Preferably, the support device may further comprise a plurality of support portions for supporting the second shelving level with respect to the first shelving level.

Preferably, one or more of the plurality of support portions may be formed as scratching posts.

A combined toileting and hygiene system according to any one of the preceding claims, wherein the litter tray is integrally formed with the first shelving level.

Preferably, the litter tray may be releasably engagable with the first shelving level.

Preferably, the container may comprise one or more litter receptacles.

Preferably, there may be provided a soiled said litter receptacle and a clean said litter receptacle.

Preferably, the container may comprise a holder for one or more of: a dustpan and brush; litter bin liners; gloves and cleansing wet wipes; trigger spray cleaning fluid; and aerosol air freshener.

The combined toileting and hygiene system may preferably further comprise a litter scoop.

Preferably, the litter scoop may comprise a handle and a shovel end, the shovel end comprising a solid section at a front end, and a grid section proximate the handle.

Preferably, the solid section of the shovel end may be or may approximately be equal in area to the grid section.

Preferably, the litter tray may have a curved edge, and the shovel end of the litter scoop has a complementarily-shaped curvature.

According to a second aspect of the present invention there is provided a litter scoop comprising a handle and a shovel end, the shovel end comprising a solid section at a front end, and a grid section proximate the handle.

Preferably, the solid section of the shovel end may be or approximately be equal in area to the grid section. Alternatively, the solid section of the shovel end may be larger in area than the grid section, the solid section of the shovel end may preferably be up to three times larger in area than the grid section.

Preferably, a top surface of the handle may comprise a non-slip surface.

According to a third aspect of the present invention there is provided a pet device, comprising a first level and a second level, wherein the second level is substantially elevated in use above the first level, and the first level is arranged to provide a litter tray for the pet.

It may be envisaged that the device is arranged for maintenance of relevant items locally, which is advantageous for pet or particularly cat carers, which users wish to have a more effective method of maintaining litter trays with minimal mess and fuss. The device of the present invention thereby:

Simplifies daily cat litter tray maintenance, improves time management

Enables easy, close access of all tools and consumables required for litter tray cleaning in small footprint

Efficient cleaning procedure and specific choice of litter reduces quantities of litter required after each clean

The device described in this application attempts to bring together all the above mentioned items, including the toiletting area, through vertical stacking. Thus the task of cleaning and maintaining the integrated toileting area beneath the device is efficient through having all of the above items in one place and close at hand above the litter tray area.

In some embodiments the first level comprises a cover for some or all of the second level.

In some embodiments the levels are separated by one or more substantially vertically arranged portions. Some embodiments the device comprises a plurality of such portions. For example in some embodiments the device comprises two levels separated by four portions, wherein the levels comprise rectangular parts.

The portions may be envisaged to be arranged in the corners of the device. The portions and levels may be arranged to be disconnected in use, so as to enable easier transport or storage.

In some embodiments it may be envisaged that the levels may comprise substantially planar parts. Such parts may further comprise upturned perimetric edges. Such edges combined with the planar parts may combine to make the levels tray-like.

Such portions may be envisaged to comprise columns. The portions may further comprise scratching posts.

It may be envisaged that the pet in use is located on the first level, underneath the second level.

In some embodiments therefore the second level comprises a means of hiding an animal in or on the first level. For example the second level may comprise a means of hiding the first level from view laterally.

In some embodiments the second level comprises a curtain for the first level in use. The second level may for example comprise one or more hanging means.

In some embodiments the device is part of an apparatus comprising a pet toileting apparatus, in particular wherein the apparatus comprises a storage container for provision of storage for items used in pet husbandry and environment cleansing.

For example such container may be used for storing and/or transporting deodorising or cleaning fluids or items, such as air fresheners and/or wipes.

The apparatus may further comprise a scoop or shovel, for control of pet litter.

The apparatus may further comprise a displaceable tray. This tray may enable the litter to be easily changed or displaced from the first level.

The second level may be arranged to accept the storage container.

In some embodiments the device may comprise an electrical energy source. Such electrical energy source may comprise a battery or mains electrical connection or socket.

In this way such embodiments may be arranged to provide one or more light source. Such light source may illuminate the first level for example. Such light source may be arranged to comprise a sensor activation, for example so as to illuminate when the animal is local.

In some embodiments the device may comprise further electrically enabled parts. For example in some embodiments the device may comprise a water circulation means, such as a fountain. For example the device may comprise a heating element.

The apparatus may thereby provide a multipurpose, space saving unit that contains several products designed for cats to use their toilet and for their owners to simplify the process of cleaning comprising a set of cleaning tools, consumables and litter storage facilities in a space saving stand that enables all tasks to be carried out in one place.

In some embodiments the device may be modular or comprise displaceable parts. For example in some embodiments it may be envisaged that the apparatus or device may be arranged so as to be used in a number of different configurations according to available space and preference of use.

Embodiments of the device thereby comprise a litter tray shelving unit that also acts a storage unit for cat litter and cleaning items, consisting of two shelving levels, one of which houses the litter tray and the other housing a storage container. The levels may be envisaged to be stacked on top of each other to save space and held in place by columnar portions forming scratching posts.

A preferred embodiment of the invention will now be described by way of example only and with reference to the Figures in which:

### BRIEF DESCRIPTION OF FIGURES

FIG. 1 shows an isometric view of an embodiment of a combined toileting and hygiene system according to a first aspect of the present invention;

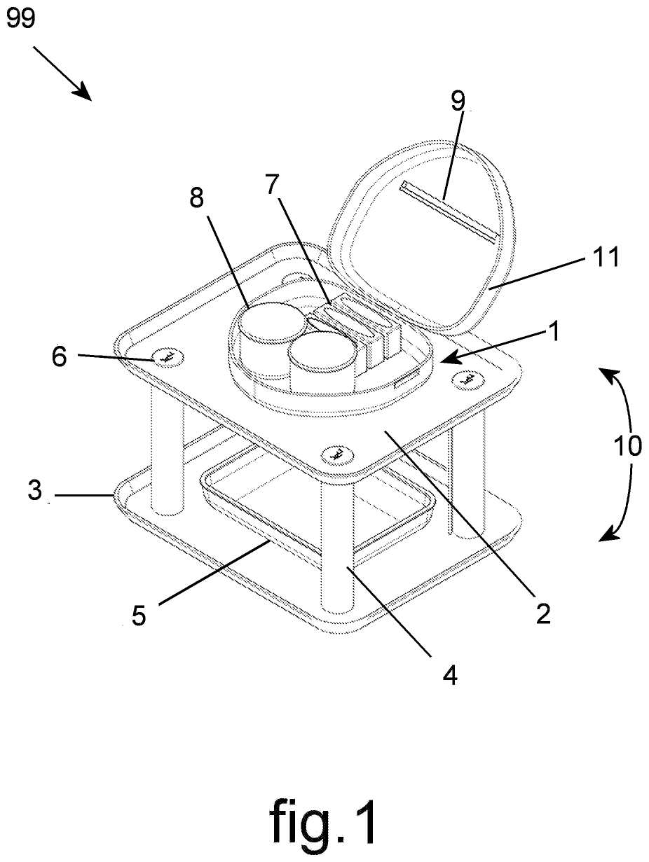

FIG. 2 shows a reverse isometric view of the embodiment shown in FIG. 1;

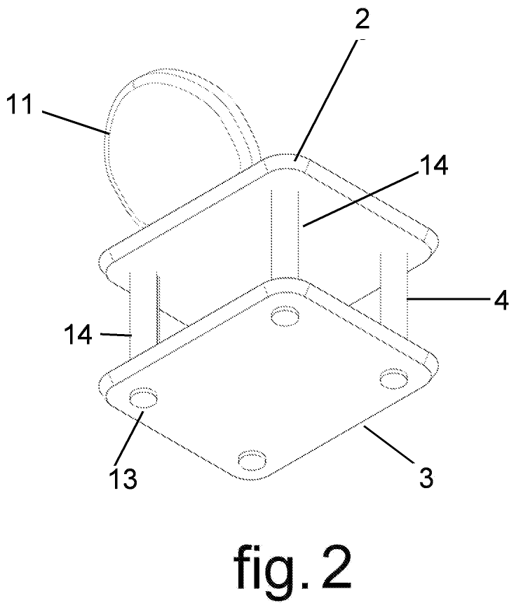

FIG. 3 shows an exploded isometric view of the embodiment of the system shown in FIG. 1;

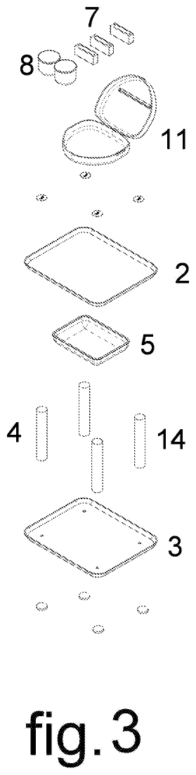

FIG. 4 shows a reverse exploded isometric view of the embodiment of the system shown in FIG. 1;

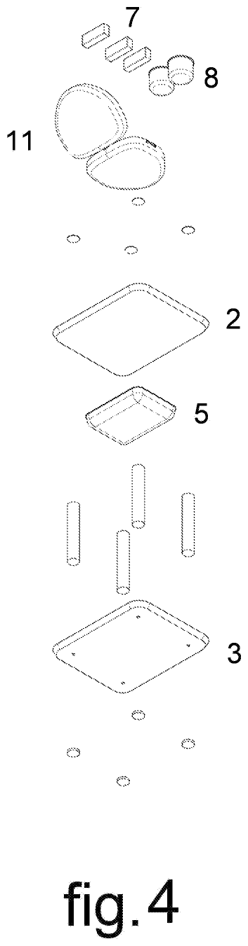

FIG. 5 shows an isometric view of a second embodiment of a combined toileting and hygiene system according to the first aspect of the present invention;

FIG. 6 shows a reverse isometric view of the embodiment shown in FIG. 5;

FIG. 7 shows an exploded isometric view of the embodiment of the system shown in FIG. 5;

FIG. 8 shows a reverse exploded isometric view of the embodiment of the system shown in FIG. 5;

FIG. 9 shows an isometric view of an embodiment of a scoop in accordance with the second aspect of the invention; and

FIG. 10 shows a reverse isometric view of the embodiment of the scoop shown in FIG. 9.

### DETAILED DESCRIPTION OF FIGURES

With reference to the figures there is generally an embodiment of the apparatus 99 comprising an embodiment of a pet device 10, comprising a first level 3 and a second level 2, wherein the second level is substantially elevated in use above the first level, and the first level is arranged to provide a litter tray 5 for the pet.

The apparatus comprises the device 10, a storage container 1, and a litter tray 5.

The embodiment of the device 10 comprises two injection moulded shelving levels 2,3 which are stacked vertically and separated by four columns portions 4,14, two of which are configured as scratching posts. The levels 2,3 are preferably formed in injection moulded polypropylene in a gloss finish. The levels may be provided as the same shape as one another, or could alternatively be provided having different shapes. By way of example only, the upper level 2 could be circular, whilst the lower level 3 could be rectangular. Any shape could be considered, such as circular, oval, polygonal, and so forth.

The litter tray 5 is located in use on the lower level and the container 1 on the upper level 2. The litter tray 5 could be integrally formed with the lower level 3 or could be releasably engagable therewith.

Where more floor space is available, the container 1 can be mounted on the floor beside the litter tray and the upper level used as a play or bedding area.

It may be envisaged that in use the container 1 contains a full complement of tools, consumables 7 and litter storage bins 8, as shown in the Figures.

For example the container 1 may comprise in use:

Two small lidded bins, one for new litter, the other for used litter;

A litter scoop with a small sifting grid of holes that enables easy separation of both solid waste and urine-soaked litter from clean, unsoiled litter;

Mini dustpan and brush; and

Other consumables; litter bin liners; gloves and cleansing wet wipes; trigger spray cleaning fluid; aerosol air freshener.

The columnar portions 4,14 are affixed to the levels 2,3 by 4× domed screw head caps 6 with lower screws mounted through feet 13 which enable the device to be placed on floor surfaces without damage.

All four columns 4,14 are fitted with 8 mm full nut inserts at each end and fastenings consist of four 8 mm pan head screws (fitted through holes in the first level's underside) and four dome-headed 8 mm screws for the second level.

It may be envisaged in the pictured embodiment that the approximate dimensions are as follows:

Litter tray—375 mm×500 mm

Device levels—525 mm×725 mm

Device columnar portions—50 mm wide 450 mm tall

A recess may be included in the top or second level to help the storage container 1 fit in place securely.

The mini dustpan/brush and the new design litter scoop may be held onto the lid 11 of the container by a quick release retaining clip and elastic loop mechanism 9.

The embodiment thereby comprises an all-in-one system aimed at making the cleaning and maintenance of a cat's litter tray a more efficient and pleasant experience. The embodiment features an upper (second) and lower (first) level, which can be stacked vertically or placed side to side. It may be envisaged that further embodiments may comprise further levels, and/or may connect vertically or laterally.

The container 1 may comprise compartments for gloves, wipes and container liners, air fresheners and antibacterial spray either as an aerosol or spray.

In the pictured embodiment the two levels comprise flat surfaces which may be used to store the container. It may be envisaged that the levels 2,3 each have non-slip surfaces.

In use a curtain (not shown) is arranged to provide a screen to hide the litter tray allowing the device and apparatus to maintain a clean look when not in use and/or giving the cat some privacy when in use. The curtain may be secured to the second level by a series of hoops, eyes, rings, hook and loop or other temporary or permanent hanging means. Other screening members could be considered, such as foldable doors or shutters, or a rigid panel which may or may not be removable.

In the pictured embodiment two rear columnar portions 14 on the rear of the device are designed to look similar to scratching posts, and may or may not be effective as such, whereas two scratching posts 4 are provided on the front columnar portions of the embodiment. Alternatively, the two rear columnar portions 14 may be plain columns. Any or all of the columnar portions 14 could be formed as scratching posts, or indeed as plain columns or similar support elements.

The curved lip to the levels and tray allows for the scoop to easily slide along the edges for a simple and very effective clean.

Feet 13 also help with picking up and moving the device.

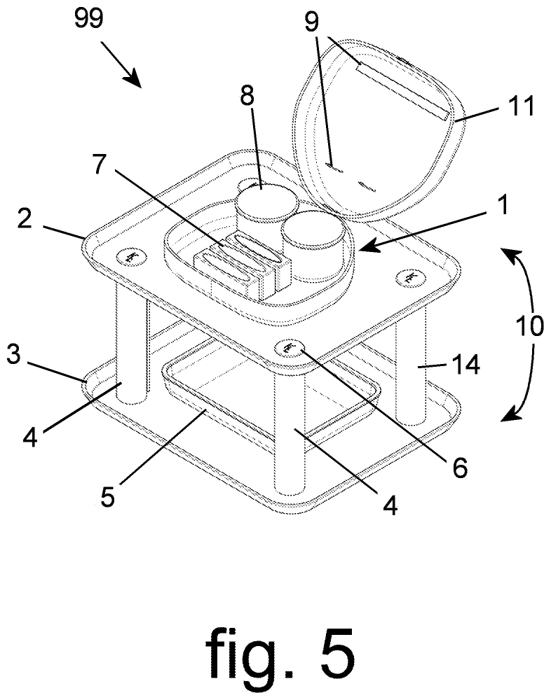

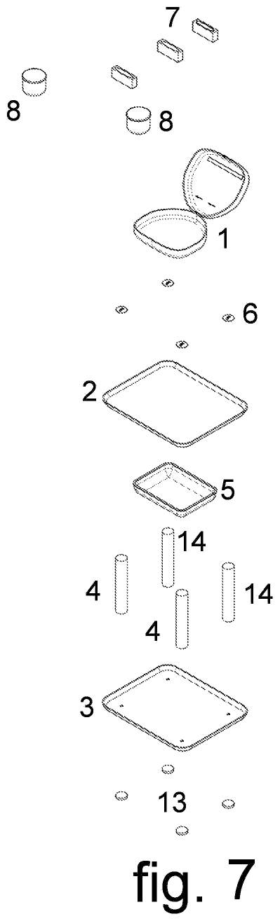

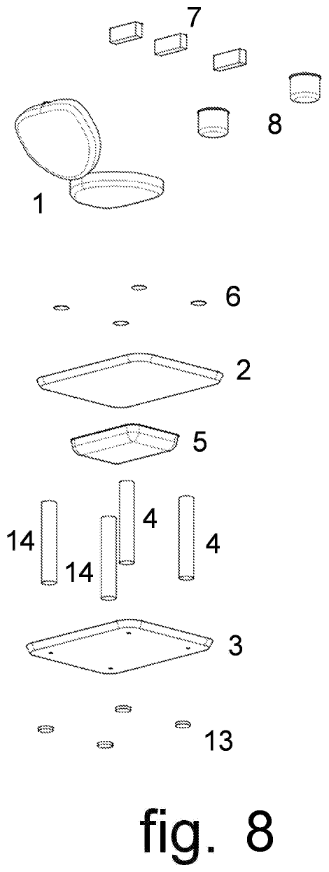

An alternative embodiment of the apparatus 99 comprising an embodiment of a pet device 10 is shown in FIGS. 5 to 8. In this instance the container 1 has a clamshell type opening mechanism, with a short hinge or pivot, when compared with the extended hinge or pivot shown in the first embodiment of the invention.

It will be noted that, whilst the device 10 has two levels, additional levels could also be provided. Furthermore, the device 10 could be constructed as a hooded unit, in which the upper level was formed as part of a lid or cover.

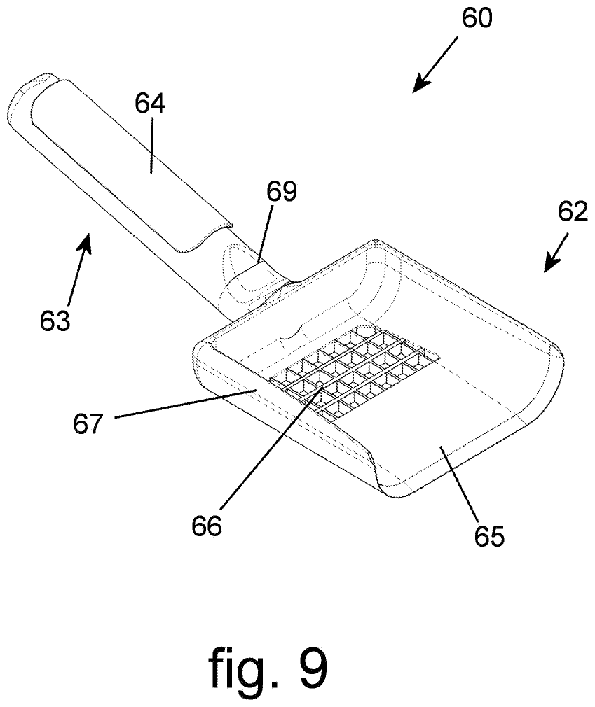

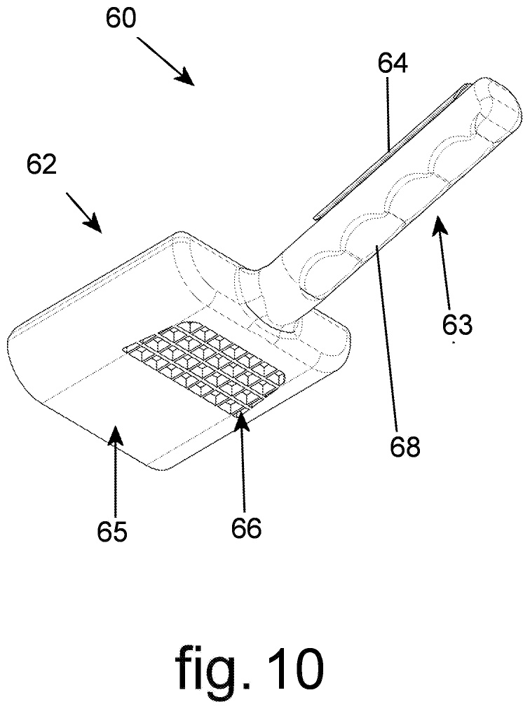

The scoop as shown in FIGS. 9 and 10 comprises a two-part scoop 60 with a shovel end 62 which has a solid section 65 at a front edge, and has a grid section 66 behind, proximate the handle 63 which allows dry, unused litter to fall through for reuse and clumped, used litter to be easily removed. A chamfered front edge allows the embodiment to scoop up fine pieces of litter from the tray or level. The chamfered front edge may be chamfered on the inner, that is scooping, surface of the shovel end 62, in order to improve pick-up of litter. Alternatively, the chamfered front edge may be chamfered on the outer, that is lower, surface of the shovel end 62, for an improved movement against the litter tray 5. Such an outer chamfered front edge may match the curvature of the litter tray 5.

The solid section 65 of the shovel end 62 is or is approximately equal in area to the grid section 66. Alternatively, the solid section 65 of the shovel end 62 may be larger in area than the grid section 66, for instance, there being a ratio of up to 3 to 1. The presence of the solid section 65 of the shovel end 62 permits more effective scooping of soiled litter using the solid section 65, when compared with existing scoops which have a complete grid section across the entire shovel end.

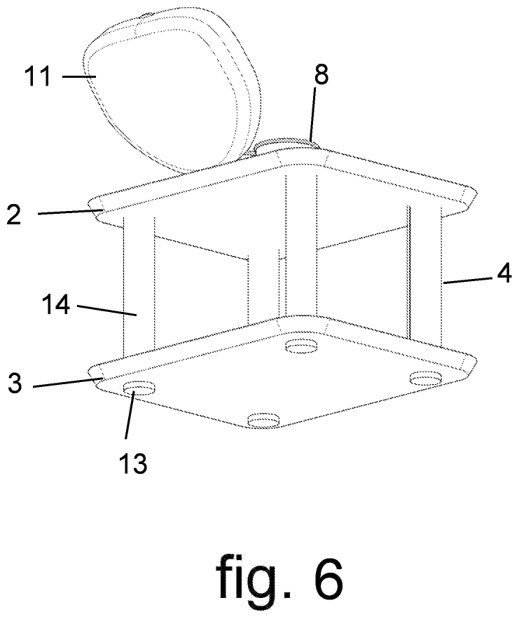

With reference to the embodiment shown in FIGS. 5 and 6 there is shown an embodiment of a scoop for use with the device or apparatus of the present invention.

The scoop comprises a non-slip surface 64 to a top surface of the handle 63.

The scoop comprises a thick handle to make the scoop more rigid, with thumb groove 69 proximate the shovel end and finger impressions on the bottom surface of the handle 63, to aid in its effective use.

The invention has been described by way of examples only and it will be appreciated that variation may be made to the above-mentioned embodiments without departing from the scope of invention as defined by the claims, in particular but not solely combination of features of described embodiments.

1. A combined toileting and hygiene system for a cat, the system comprising: a support device having a first shelving level and a second shelving level, the second shelving level being vertically elevated with respect to the first shelving level; a litter tray associated with the first shelving level; and a container on the second shelving level which is dimensioned to hold one or more hygiene items for the litter tray.

2. A combined toileting and hygiene system according to claim 1 further comprising a screening member which is positionable between the first and second shelving levels.

3. A combined toileting and hygiene system according to claim 2, wherein the screening member is a curtain which hangs from the second shelving level.

4. A combined toileting and hygiene system according to claim 1, wherein at least one of the first and second shelving levels comprises substantially planar surfaces.

5. A combined toileting and hygiene system according to claim 4, wherein a perimetric edge of the at least one of the first and second shelving level curves upwardly.

6. A combined toileting and hygiene system according to claim 1, wherein the support device further comprises a plurality of support portions for supporting the second shelving level with respect to the first shelving level.

7. A combined toileting and hygiene system according to claim 6, wherein one or more of the plurality of support portions are formed as scratching posts.

8. A combined toileting and hygiene system according to claim 1, wherein the litter tray is integrally formed with the first shelving level.

9. A combined toileting and hygiene system according to claim 1, wherein the litter tray is releasably engagable with the first shelving level.

10. A combined toileting and hygiene system according to claim 1, wherein the container comprises one or more litter receptacles.

11. A combined toileting and hygiene system according to claim 10, wherein there is provided a soiled said litter receptacle and a clean said litter receptacle.

12. A combined toileting and hygiene system according to claim 1, wherein the container comprises a holder for one or more of: a dustpan and brush; litter bin liners; gloves and cleansing wet wipes; trigger spray cleaning fluid; and aerosol air freshener.

13. A combined toileting and hygiene system according to claim 1, further comprising a litter scoop.

14. A combined toileting and hygiene system according to claim 13, wherein the litter scoop comprises a handle and a shovel end, the shovel end comprising a solid section at a front end, and a grid section proximate the handle.

15. A combined toileting and hygiene system according to claim 14, wherein the solid section of the shovel end is or is approximately equal in area to the grid section.

16. A combined toileting and hygiene system according to claim 13, wherein the litter tray has a curved edge, and the shovel end of the litter scoop has a complementarily-shaped curvature.
